(19) United States
(12) Patent Application Publication
(10) Pub. No.: US 2014/0019361 A1
(43) Pub. Date: Jan. 16, 2014

(54) ONLINE PAYMENT USING REAL-TIME VERIFICATION OF A PAYER'S IDENTITY

(71) Applicants: Stephen Bering, University Place, WA (US); Jacob Fournier, University Place, WA (US); Danny Joe, Gig Harbor, WA (US); John P. Kerher, Lakewood, WA (US); Kenneth L. Lomax, Auburn, WA (US); Hai Vu Nguyen, Des Moines, WA (US); Linda Remsberg, Tacoma, WA (US); Tanvir Sidhu, Lakewood, WA (US); Tania Stephens, Galt, CA (US)

(72) Inventors: Stephen Bering, University Place, WA (US); Jacob Fournier, University Place, WA (US); Danny Joe, Gig Harbor, WA (US); John P. Kerher, Lakewood, WA (US); Kenneth L. Lomax, Auburn, WA (US); Hai Vu Nguyen, Des Moines, WA (US); Linda Remsberg, Tacoma, WA (US); Tanvir Sidhu, Lakewood, WA (US); Tania Stephens, Galt, CA (US)

(21) Appl. No.: 13/941,333

(22) Filed: Jul. 12, 2013

Related U.S. Application Data
(60) Provisional application No. 61/670,992, filed on Jul. 12, 2012.

(51) Int. Cl. G06Q 20/40

(52) U.S. Cl. CPC G06Q 20/40
USPC 705/44

(57) ABSTRACT

A system and/or method of authenticating the identity of a user desiring to conduct a transaction using an electronic device.

### BACKGROUND OF THE INVENTION

Micro transactions have been used for the purpose of authenticating a particular individual, not physically present (over the web, or electronically). A micro transaction is when a small (less than twenty, $0.20, cent) deposit is placed in a consumer's account. The consumer then waits 24-48 hours to see the amount deposited and reports back to the initiating company the amounts deposited. This is considered commercially viable for ACH authentication.

The time it takes (24-48 hours) to authenticate is the main deterrent to that method. This means ACH payments can't be scheduled immediately

### BRIEF DESCRIPTION OF THE DRAWINGS

FIG. 1 is a flowchart illustrating a method according to an embodiment of the invention; and

FIGS. 2-8 are screen shots illustrating functionality of at least one embodiment of the invention.

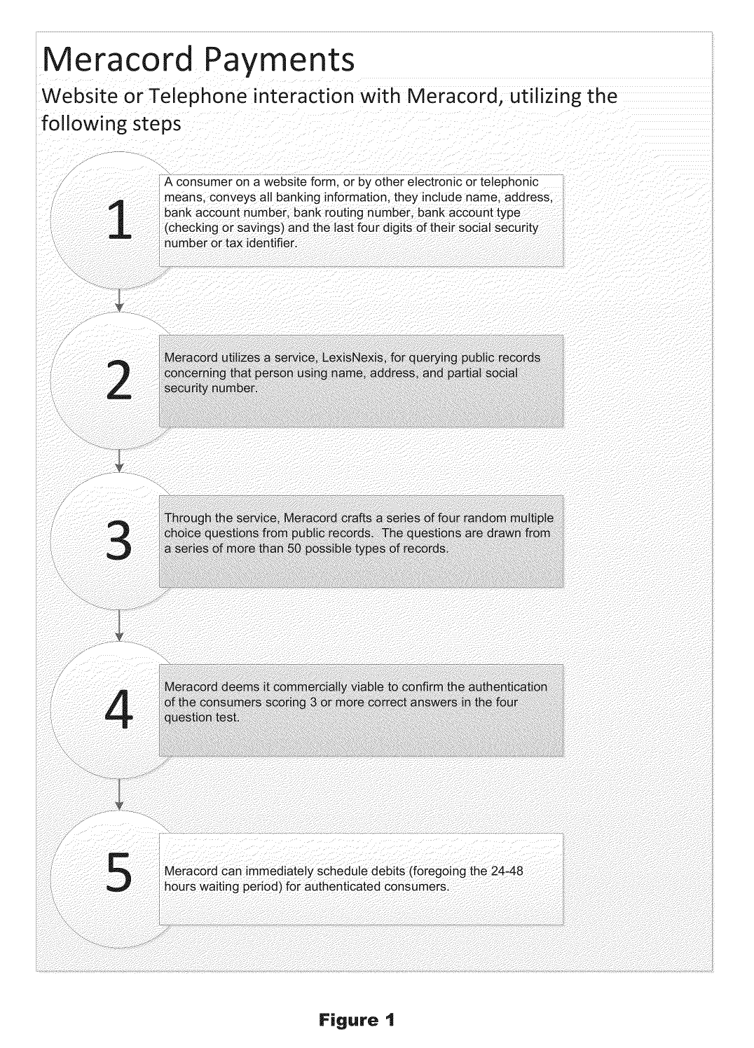

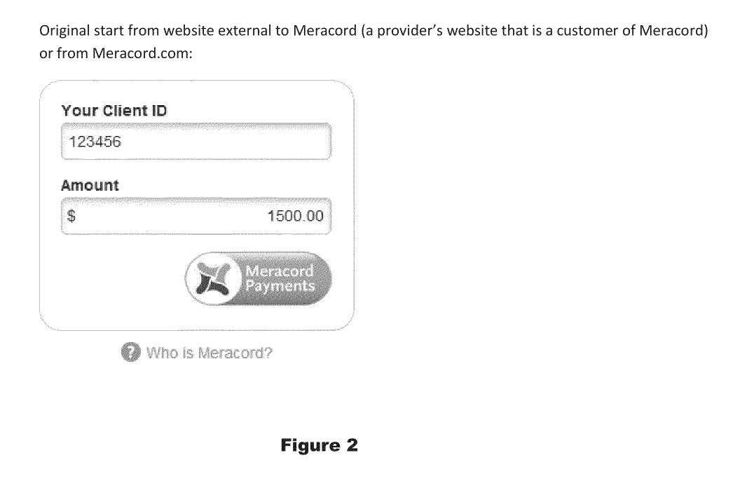

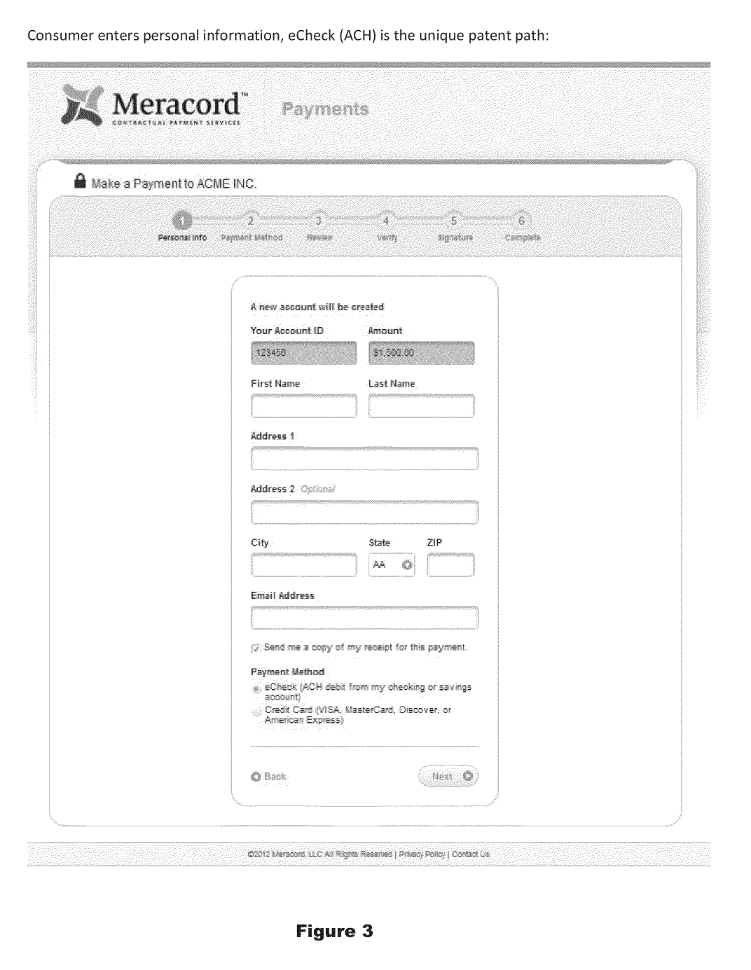

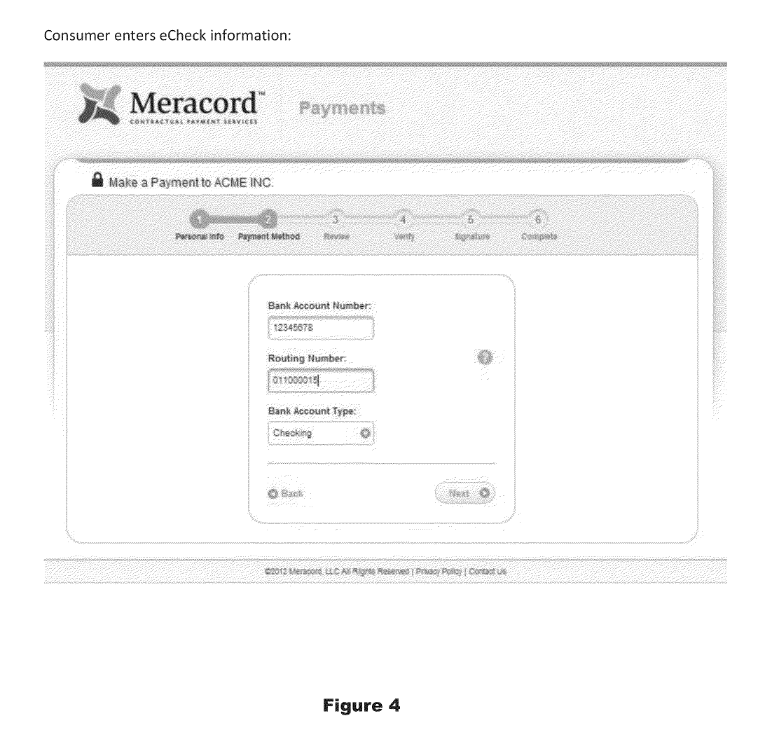

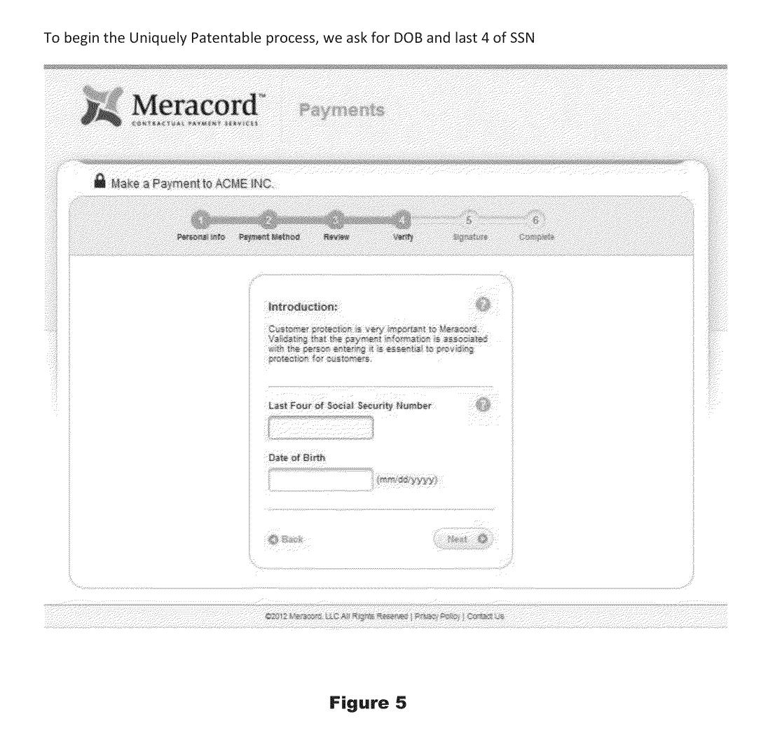

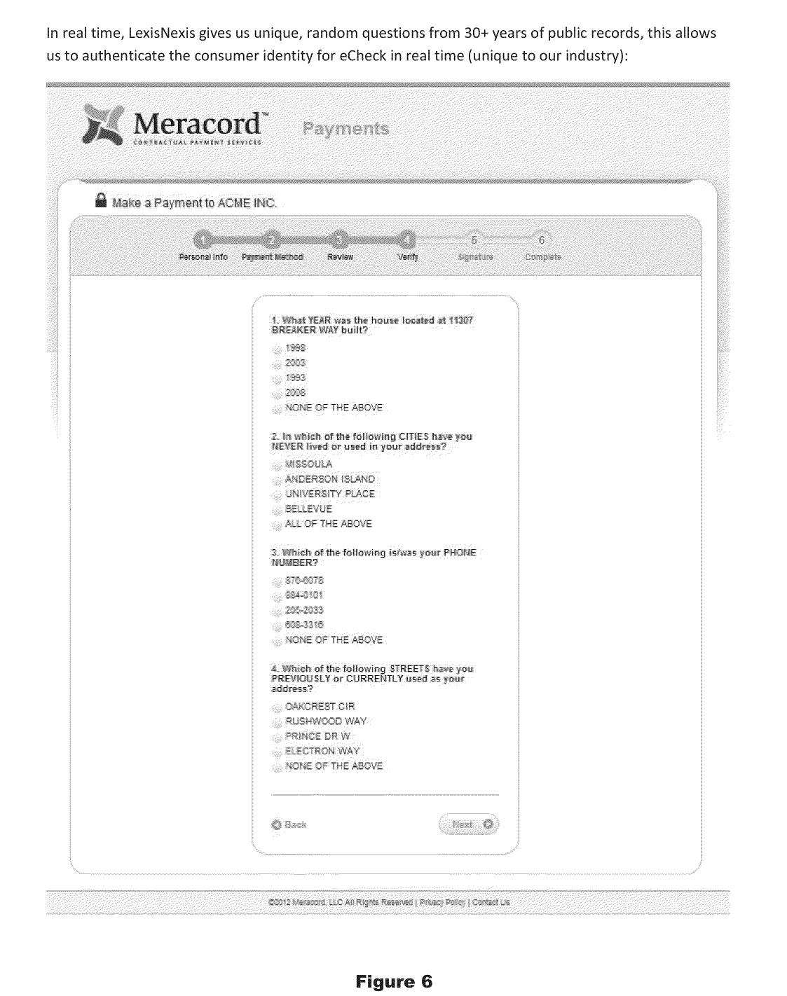

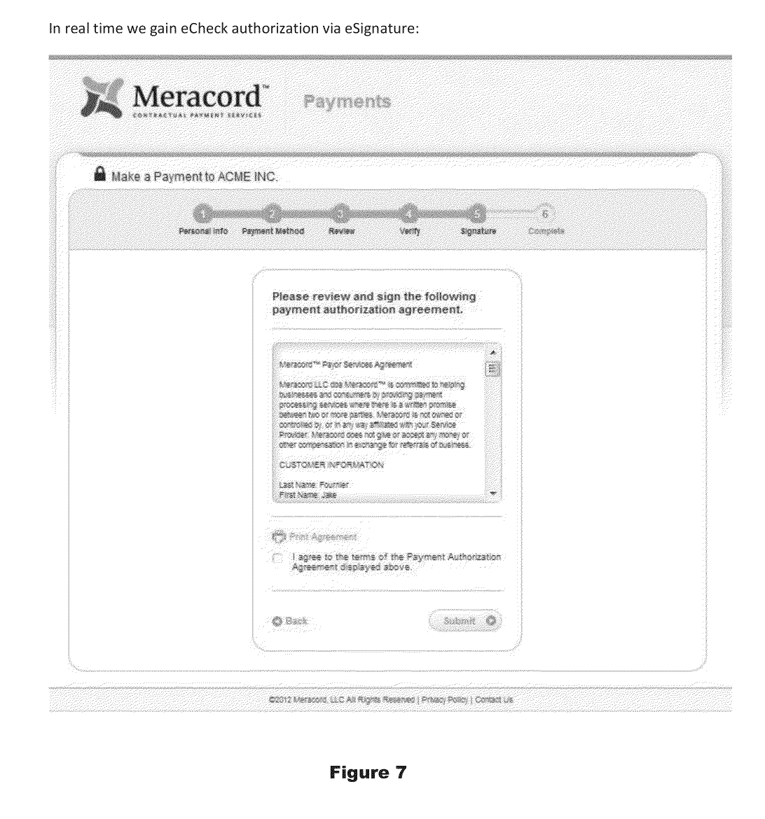

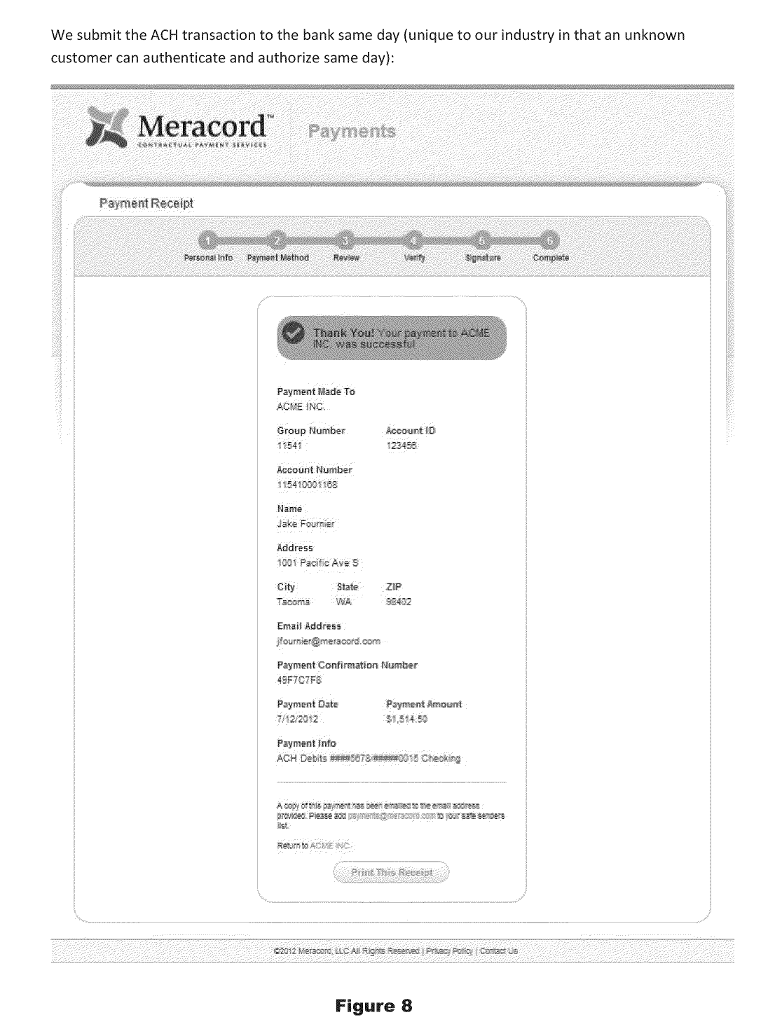

### DETAILED DESCRIPTION

This patent application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

Embodiments of the invention may be operational with numerous general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Embodiments of the invention may be described in the general context of computer-executable instructions, such as program modules, being executed by a computer and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Embodiments of the invention may include or be implemented in a variety of computer readable media. Computer readable media can be any available media that can be accessed by a computer and includes both volatile and nonvolatile media, removable and non-removable media. By way of example, and not limitation, computer readable media may comprise computer storage media and communication media. Computer storage media include volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

An embodiment provides a system and/or method of authenticating the identity of a user desiring to conduct a transaction using an electronic device. An embodiment of the invention involves taking immediately authenticated ACH (ACH, Debit or eCheck) payments from a checking or savings electronically. This may involve “Inline” or “Inter-process” authentication of a consumer using public record data; data dating back 30 years, for example. The question offering is random and therefore cannot be researched in advance. Correct answers are never exposed to consumers, only validation the consumer has, or has not authenticated.

At least one embodiment may be implemented in the following manners:

Website form—consumer enters their own information.

Interactive voice response systems (telephone)—consumer uses a phone system to enter information via touchtone or voice.

Customer service staff rendering the form in proprietary desktop software—Consumer needs assistance entering information as they have no access to the internet.

The steps, in an embodiment, are as follows:
1. As a matter of process, a consumer on a website form, or by other electronic or telephonic means, conveys all banking information, they include name, address, bank account number, bank routing number, bank account type (checking or savings) and the last four digits of their social security number or tax identifier.
2. Meracord utilizes one or more services for querying public records concerning that person using name, address, and partial social security number.
3. Using the public records provided through the service, Meracord crafts a series of four random multiple-choice questions. Alternatively, the questions are not multiple-choice, and require the consumer to input, using alphanumeric characters, the correct response into a conventional displayed data-entry field. The questions are drawn from a series of more than 50 possible types of records.
4. Meracord deems it commercially viable to confirm the authentication of the consumers scoring 3 or more correct answers in the four question test (i.e., a predetermined percentage of correct answers).
5. Meracord can immediately schedule debits (foregoing the 24-48 hours waiting period) for authenticated consumers.

What is claimed is:

1. A method, comprising steps described above herein.
